(19) United States
(12) Patent Application Publication
(10) Pub. No.: US 2007/0279013 A1
(43) Pub. Date: Dec. 6, 2007

(54) Method and apparatus for setting a setpoint output voltage of a generator which is disposed in a motor vehicle

(75) Inventors: Gregor Biskup, Kampfelbach Ersingen (DE); Bernhard Ritter, Pforzheim (DE); Dejan Djordjevic, Stuttgart (DE)

Correspondence Address: LERNER GREENBERG STEMER LLP, P O BOX 2480, HOLLYWOOD, FL, 33022-2480, US

(73) Assignee: Dr. Ing. h.c. F. Porsche AG

(21) Appl. No.: 11/804,680

(22) Filed: May 18, 2007

(30) Foreign Application Priority Data
May 18, 2006 (DE) 10 2006 023 275.5

(51) Int. Cl. H02H 7/06; H02P 9/00; H02P 11/00

(52) U.S. Cl. 322/28

(57) ABSTRACT

A method and an apparatus set a setpoint output voltage of a generator that is disposed in a motor vehicle. The setpoint output voltage of the generator is lowered if the setpoint output voltage exceeds a prespecified first threshold value and if an actuation signal for a fan for cooling a motor of the motor vehicle reaches or exceeds a second threshold value.

### CROSS-REFERENCE TO RELATED APPLICATION

This application claims the priority, under 35 U.S.C. § 119, of German application DE 10 2006 023 275.5-34, filed May 18, 2006; the prior application is herewith incorporated by reference in its entirety.

### BACKGROUND OF THE INVENTION

### Field of the Invention

The present invention relates to a method and an apparatus for setting a setpoint output voltage of a generator that is disposed in a motor vehicle.

A motor vehicle usually has a generator, also called an alternator, which has to fulfill different tasks. The main task of the generator is to charge a battery of the motor vehicle. The battery emits a large amount of stored energy, particularly for starting the motor vehicle. Therefore, the battery should again be supplied with energy after starting. This is done by the generator that is connected to the battery. The generator supplies the battery with a current by which the battery is recharged. The generator is also used to supply current to other electrical loads of the motor vehicle. One such load is a fan that serves to cool a motor that is used to drive the motor vehicle. The fan has an associated actuation device that generates an actuation signal for actuating the fan. An output voltage that is to be provided by the generator at its output during operation is usually specified to the generator in advance by a set point output voltage.

### SUMMARY OF THE INVENTION

It is accordingly an object of the invention to provide a method and an apparatus for setting a setpoint output voltage of a generator which is disposed in a motor vehicle which overcome the above-mentioned disadvantages of the prior art methods and devices of this general type, which ensures efficient operation of a fan for cooling a motor of a motor vehicle in a technically simple manner.

With the foregoing and other objects in view there is provided, in accordance with the invention, a method for setting a setpoint output voltage of a generator disposed in a motor vehicle. The method includes the step of lowering the setpoint output voltage of the generator if the setpoint output voltage exceeds a prespecified first threshold value and if an actuation signal for a fan for cooling a motor of the motor vehicle reaches or exceeds a second threshold value.

According to the invention, the setpoint output voltage of the generator is lowered if it exceeds a prespecified first threshold value and an actuation signal for a fan for cooling a motor of the motor vehicle reaches or exceeds a second threshold value.

During operation of the motor vehicle, it is advantageous for the generator, if appropriate for a limited time period, to provide a high output voltage and emit a high current with which a battery of the motor vehicle can be rapidly charged. This is particularly advantageous particularly for a specific time period after starting of the motor vehicle in order to rapidly supply the battery with energy consumed during starting. By virtue of the present invention, it is advantageously possible to prevent an actuation device, which is used to actuate the fan, contains electronic components and is likewise connected to the output of the generator in order to be supplied with power, from being damaged by the high output voltage of the generator under specific operating conditions. In this case, the fan is particularly a motor-operated fan whose motor is actuated by the actuation signal. According to the invention, a suitable prespecified value of the setpoint output voltage of the generator can be permitted in order to thus ensure problem-free operation of the fan. The setpoint output voltage of the generator is advantageously lowered to a prespecified limit voltage. This limit voltage can be of such a magnitude that the fan reaches its prespecified setpoint rotational speed while the setpoint output voltage is lowered.

In one advantageous refinement of the invention, an external temperature is determined and the setpoint output voltage is only lowered if the external temperature reaches or exceeds a prespecified third threshold value. Taking account of the external temperature prevailing outside the motor vehicle enables the setpoint output voltage of the generator to be set even more effectively since a particularly good compromise is achieved between the fastest possible charging of the battery by a high output voltage of the generator and the prevention of damage to the actuation device for the fan. If the external temperature is below the third threshold value, it can be assumed that cooling from the outside is so great that it makes a substantial contribution to cooling of the motor of the motor vehicle. In this case, the fan has to provide a correspondingly lower output power.

The setpoint output voltage is preferably only lowered if, as it rises, the actuation signal for the fan reaches or exceeds the second threshold value. It is precisely in a rise phase of the actuation signal that the risk of damage to the actuation device is particularly great since the fan itself does not require such a high current which leads to sufficient limiting of the output voltage of the generator.

In a further advantageous refinement, the setpoint output voltage is lowered for a prespecified first time period. This time period is advantageously of such a length that it can be assumed that, after the first time period has elapsed, the output power of the fan is so great that the fan itself draws a sufficiently high current to suitably limit the output voltage of the generator. The setpoint output voltage of the generator advantageously remains lowered during the first time period, irrespective of the profile of the actuation signal for the fan. After the first time period has elapsed, the setpoint output voltage of the generator is therefore released again and can assume a value that is above the first threshold value. It should be noted here that the output voltage actually present can deviate from the setpoint output voltage of the generator.

In one particularly preferred refinement of the invention, a pressure of a refrigerant for an air-conditioning device of the motor vehicle is determined and the setpoint output voltage is lowered if the determined pressure reaches or exceeds a prespecified fourth threshold value. As a result, an additional safety precaution is taken since, particularly in the event of a malfunction of the fan or its actuation system under unfavorable conditions for the air-conditioning device, for example caused by a high system output of the air-conditioning device or a high external temperature, the pressure of the refrigerant can rise quickly and cause problems. The fan can additionally be used to cool the refrigerant, with the result that correct operation of the fan is relevant for the behavior of the refrigerant. The high pressure of the refrigerant is an indication of a malfunction. For the sake of safety, it is advantageous to lower the setpoint output voltage of the generator, particularly when it is initially not exactly clear what the fault is.

The setpoint output voltage of the generator is preferably lowered until the pressure of the refrigerant reaches or falls below a prespecified fifth threshold value. In this case, the fifth threshold value is advantageously defined such that it is ensured that the pressure is low enough to no longer present any safety risk.

The fifth threshold value is particularly preferably lower than the fourth threshold value. This provides an additional safety feature which also makes the system more stable. A kind of hysteresis is therefore implemented in the setting process for the setpoint output voltage.

In one advantageous refinement, a second time is determined during which the setpoint output voltage is lowered as a function of the determined pressure. Determination of the second time can be used for further control purposes and therefore leads to a further improvement in the setting process for the setpoint output voltage.

In a further advantageous refinement, times during which the setpoint output voltage of the generator is lowered are added up and a charging period for charging a battery of the motor vehicle is extended as a function of these added times. This ensures that the charging balance for charging the battery is precisely maintained.

When it is lowered, the setpoint output voltage of the generator is particularly advantageously lowered to the first threshold value. This ensures that the setpoint output voltage is lowered in a reliable manner and to a sufficiently great degree and at the same time keeps the outlay on implementation for setting the setpoint output voltage low since one threshold value fulfills two functions.

Other features which are considered as characteristic for the invention are set forth in the appended claims.

Although the invention is illustrated and described herein as embodied in a method and an apparatus for setting a setpoint output voltage of a generator which is disposed in a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, block diagram illustrating basic components of a motor vehicle;

FIG. 2 is a graph showing a profile of a signal for setting a setpoint output voltage of a generator as a function of signal profiles of an actuation signal of a fan and of a pressure of a refrigerant according to the invention;

FIG. 3 is a graph showing a profile of a charging signal for charging a battery of the motor vehicle; and

FIG. 4 is a graph showing a profile of the signal for setting the setpoint output voltage of the generator, additionally as a function of a profile of an external temperature.

### DESCRIPTION OF THE PREFERRED EMBODIMENTS

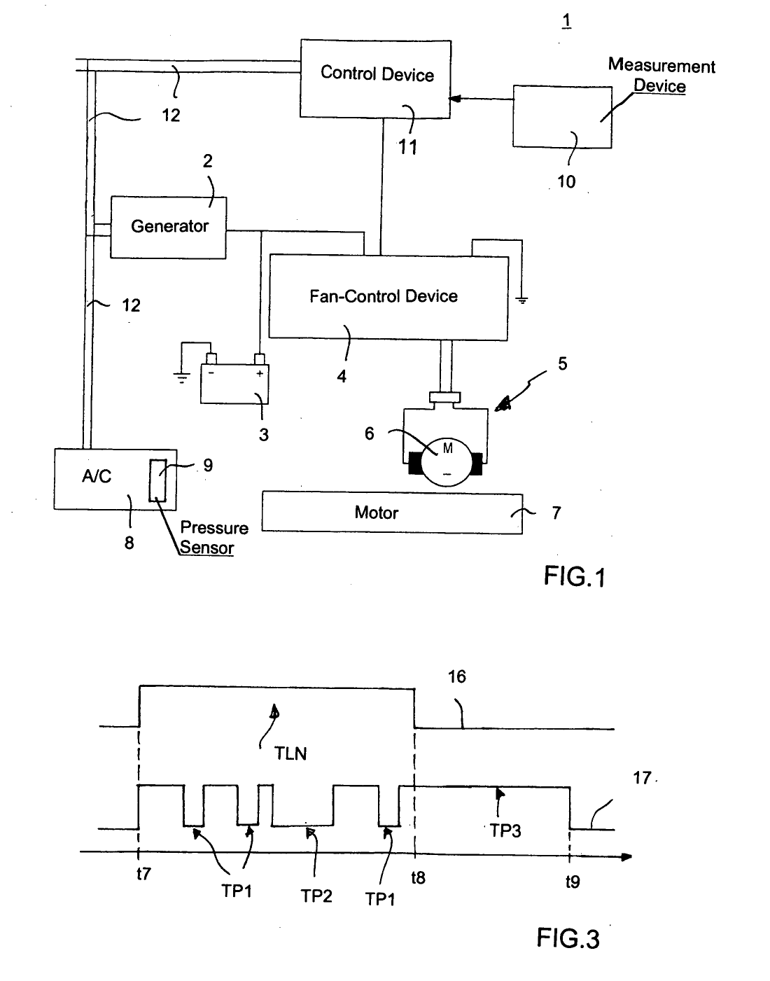

The same reference symbols are used for identical or identically acting elements throughout the text which follows. Referring now to the figures of the drawing in detail and first, particularly, to FIG. 1 thereof, there is shown a schematic basic illustration of components of a motor vehicle 1. The motor vehicle 1 has a generator 2 which is connected to a battery 3. The generator 2 and the battery 3 are connected to a fan-control device 4 for actuating a fan 5. The fan 5 has a DC motor 6 and serves to cool a motor 7, in particular an internal combustion engine, for driving the motor vehicle 1. The motor vehicle 1 also has an air-conditioning system 8 which serves, in particular, to control a temperature of a passenger compartment of the motor vehicle 1. A refrigerant is used in order to operate the air-conditioning system 8, and the pressure of the refrigerant can be changed as a function of operating conditions and conditions outside the motor vehicle 1, primarily an external temperature. A pressure sensor 9 is provided in order to determine the pressure of the refrigerant. Knowledge of the external temperature prevailing outside the motor vehicle 1 is particularly relevant for setting the fan 5 and the air-conditioning system 8 here. The motor vehicle 1 therefore contains a measurement device 10 for measuring the external temperature. The measurement device 10 is connected to a control device 11 which serves to control the operating modes and actions of the various components of the motor vehicle 1. The control device 11 receives information about the external temperature from the measurement device 10. The control device 11 is connected to the generator 2, the air-conditioning system 8 and further non-illustrated components of the motor vehicle 1 via a bus 12. The control device 11 is also connected to the fan-control device 4.

The fan-control device 4 receives an actuation signal for actuating the fan 5 from the control device 11. The actuation signal specifies the power with which the fan 5 should be operated in order to cool the motor 7. The fan-control device 4 processes the actuation signal in a suitable manner for actuating the fan 5 and then accordingly actuates the fan. The fan-control device 4 contains electronic components which are supplied with voltage by the generator 2. The generator 2 therefore provides an output voltage to the fan-control device 4 at its output. Since the output of the generator 2 is connected to a positive terminal of the battery 3, the generator 2 also provides its output voltage to the battery 3. As a result, a current flows from the generator 2 to the battery 3, the current serving to charge the battery 3. The generator 2 receives from the control device 11, via the bus 12, an actuation signal with a setpoint output voltage that represents a prespecified value for setting the output voltage at the output of the generator 2. In the present exemplary embodiment, no check is made as to whether the output voltage actually emitted at the output of the generator 2 corresponds to the setpoint output voltage. However, it is possible to set up such a check and a suitable regulating system for the actual output voltage.

According to the invention, the setpoint output voltage is set by the control device 11 as a function of the actuation signal for the fan 5. To this end, a threshold value B1 for the setpoint output voltage of the generator 2 is specified to the control device 11 in advance. The control device 11 checks whether the setpoint output voltage for the generator 2 which it prespecifies exceeds this threshold value B1 or not. A threshold value P1 for the actuation signal of the fan 5 is also specified to the control device 11 in advance. The threshold value P1 can be parameterized and therefore can be set as a function of specific prespecified values. The control device 11 checks whether the actuation signal for the fan 5 reaches the threshold value P1 or not. In the present exemplary embodiment, the control device 11 also checks whether the actuation signal reaches the threshold P1 in a rising signal phase, that is to say coming from a lower value, or in a falling signal phase, that is to say coming from a higher value. A threshold value P2 for a determined pressure of the refrigerant of the air-conditioning system 8 is furthermore specified to the control device 11 in advance. The threshold value P2 can be parameterized and therefore can be set as a function of specific prespecified values. The control device 11 checks whether the pressure of the refrigerant detected by the pressure sensor 9 exceeds the threshold value P2 or not. The setpoint output voltage of the generator 2 is set as a function of the checks made by the control device 11 with respect to the threshold values B1, P1 and P2.

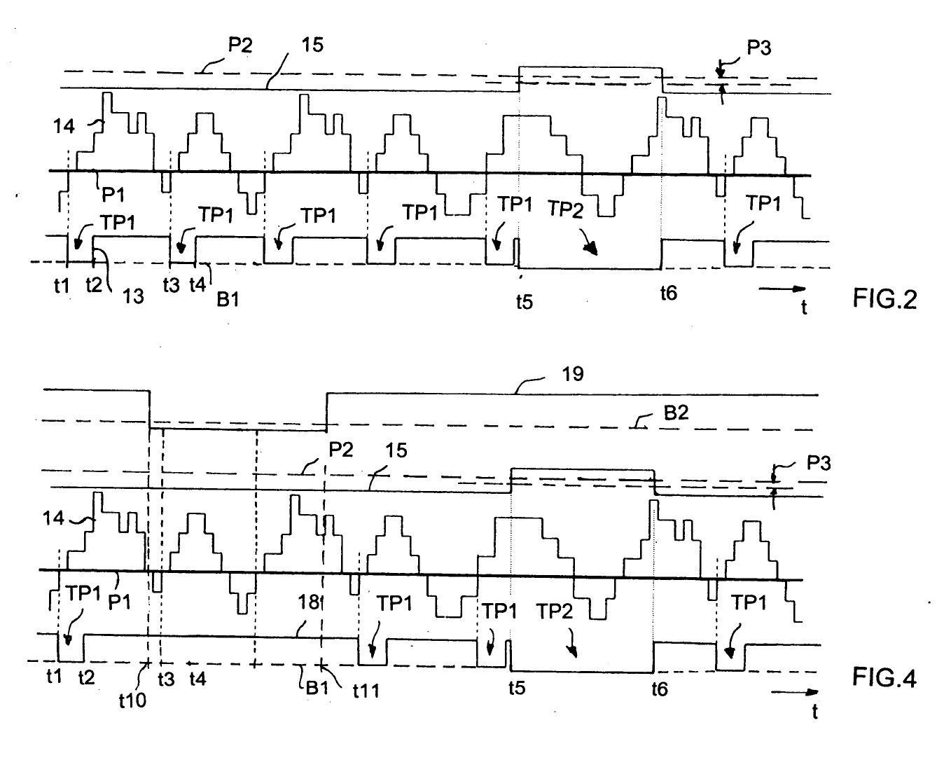

FIG. 2 shows a time profile of a signal 13 of the setpoint output voltage of the generator 2 as a function of a time profile of an actuation signal 14 of the fan 5 and a time profile of a pressure signal 15 for the pressure in the refrigerant of the air-conditioning system 8. FIG. 2 also shows the threshold values B1, P1 and P2. The profiles of the signals illustrated in FIG. 2 can occur in the motor vehicle 1, particularly after it is started. The battery 3 has emitted energy in order to start the motor vehicle 1 and should be recharged by the generator 2. To this end, a high output voltage is advantageously emitted by the generator 2, with the result that the battery 3 can be rapidly charged by a high current.

According to the illustration in FIG. 2, a signal 13 which is transmitted to the generator 2 by the control device 11 is initially at a high level and is above the threshold value B1. This means that a high setpoint output voltage is specified to the generator 2 by the control device 11 in advance. The high setpoint output voltage may, for example, be 15 V. The actuation signal 14 for the fan 5 is initially below the threshold value P1 and is in a rising phase. Here, the actuation signal 14 prespecifies the power of the fan 5. The pressure signal 15 is initially below the threshold value P2. That is to say the pressure in the refrigerant is below the critical value of, for example, 20 bar prespecified by the threshold value P2. The actuation signal 14 reaches the threshold value P1 in a rising signal phase at time t1. Here, the threshold value P1 is, for example, 70% of the maximum power which can be emitted by the fan 5. In the rising signal phase, the fan 5 requests that its power output be increased in order to provide greater cooling. The control device 11 identifies that the threshold value P1 is reached. It then allows the output voltage of the generator 2 to be lowered by controlling a lowering operation of the setpoint output voltage by correspondingly changing the signal 13. At time t1, the signal 13 is lowered to the value of the threshold value B1. The value of the threshold value B1 is, for example, 14.3 V. It is likewise possible to lower the signal 13 to a value which differs from the value of the threshold value B1. The setpoint output voltage is lowered, on account of the threshold value P1 being reached by the rising actuation signal 14, for a prespecified time period TP1. Time period TP1 lasts, for example, 20 s. During time period TP1, the setpoint output voltage remains set at threshold value B1 irrespective of the further profile of the actuation signal 14. In the present exemplary embodiment, the actuation signal 14 continues to rise in a step-like manner during time period TP1. Time period TP1 elapses at time t2 and the signal 13 is again set at the high level. This is done independently of the level of the actuation signal 14, which is above the threshold value P1 at time t2. In this situation, the fan 5 is operated at a very high power, with the result that it draws a large current. As a result, the fan 5 itself limits the actual output voltage of the generator 2. The actuation signal 14 rises and falls in a step-like manner, finally falls below the threshold value P1 again in a falling signal phase, then reverses again in a rising signal phase and again reaches the threshold value P1 at time t3. At time t3, the signal 13 is therefore again lowered to the low level of the threshold value B1 for a further time period TP1. At time t4, after time period TP1 has elapsed, the signal 13 is released again and can be set at its high level. This procedure of lowering and raising the signal 13 is carried out a further four times according to FIG. 2.

At time t5, the signal 13 is at its high level, the actuation signal 14 is above the threshold value P1 and the pressure signal 15 exceeds the threshold value P2. Therefore the pressure in the refrigerant of the air-conditioning system 8 has reached a critical value. For safety purposes, the signal 13 is therefore lowered to the low level of the threshold value B1 irrespective of the actuation signal 14 at time t5. The pressure of the refrigerant is further established by the pressure sensor 9 and further checked by the control device 11. The signal 13 remains at its low level until the pressure of the refrigerant again falls below the threshold value P2 and an additional safety reserve P3 which is, for example, 2 bar. In the present exemplary embodiment, this is the case at time t6. The signal 13 is therefore again increased to the high level at time t6. A time period TP2, during which the signal 13 is lowered on account of the high pressure of the refrigerant, is determined.

The control device 11 is configured such that it adds up the various time periods TP1 and TP2 during which the signal 13 is lowered to form a time period TP3. The control device 11 advantageously uses the time period TP3 to extend a charging period for charging the battery 3 compared to a normal charging period without lowering of the setpoint output voltage of the generator 2. Lowering the setpoint output voltage of the generator 2 results in that the high level of the setpoint output voltage on which the normal charging period is based is not available to the battery during time periods TP1 and TP2. As a result, only a reduced current flows into the battery 3, with the result that the battery is charged more slowly. In order to compensate for this, the control device 11 extends the charging period by time period TP3, during which the signal 13 is at its high level.

This is illustrated by way of example in FIG. 3 which illustrates a profile of a charging signal 16 for charging the battery 3 of the motor vehicle 1. The basis of the charging signal 16 is a situation for a specific time of, for example, 30 minutes after starting of the motor vehicle 1, in which case the battery 3 has emitted a large proportion of its stored energy for starting purposes. The battery 3 is recharged in the situation on which the signal 16 is based by the setpoint output voltage which is specified to the generator 2 in advance and which is at its high level during the entire charging operation. The setpoint output voltage of the generator 2 is not lowered. The charging operation is started immediately after starting at time t7. Charging by the high level of the setpoint output voltage is then carried out for a normal charging period TLN. The charging operation is then ended at time t8 since the battery 3 has reached its full charge state again.

FIG. 3 also illustrates a signal 17 which is based on a situation in which recharging of the battery 3 is delayed by the setpoint output voltage being lowered several times. Lowering operations of this type which are carried out during time periods TP1 and TP2 are illustrated in FIG. 3. In contrast to signal 16, the charging operation of the battery 3 is not terminated at time t8 in the case of signal 17. Instead, signal 17 continues to remain at its high level. The charging time according to signal 17 is extended by time period TP3 which is determined by the control device 11. Time period TP3 begins at time t8 and ends at time t9, at which the charging operation is terminated in the case of signal 17. Signals 16 and 17 ideally represent signals for the setpoint output voltage of the generator 2.

FIG. 4 shows a time profile of a signal 18 for setting the setpoint output voltage of the generator 2. Like the signal 13 from FIG. 2, the signal 18 is set as a function of the time profile of the actuation signal 14 of the fan 5 and the time profile of the pressure signal 15 for the pressure in the refrigerant of the air-conditioning system 8. The signals 14 and 15 and the threshold values B1, P1, P2 and P3 correspond to those of FIG. 2. In the exemplary embodiment according to FIG. 4, the setpoint output voltage according to signal 18 is additionally set as a function of an external temperature outside the motor vehicle 1. The time profile of the external temperature is illustrated in FIG. 4 by signal 19. A threshold value B2 which is, for example, 15° C. is specified for the external temperature in advance. The external temperature is determined and transmitted to the control device 11 by the measurement device 10. The control device establishes whether the external temperature falls below the threshold value B2 or not. If the external temperature falls below the threshold value B2, the setpoint output voltage for the generator 2 is then not lowered if this were to be necessary on account of the profile of the actuation signal 14. As illustrated in FIG. 4, the external temperature according to signal 19 is initially above the threshold value B2. As in the exemplary embodiment according to FIG. 2, the setpoint output voltage, as shown by signal 18, is therefore also lowered at time t1 for the time period TP1 here. At time t10, which follows time t2 but precedes time t3, the external temperature falls below the threshold value B2. At time t3, at which the external temperature is below the threshold value B2 and in addition the setpoint output voltage therefore has to be lowered on account of the actuation signal 14, the setpoint output voltage is not lowered. The same applies to the next lowering operation which follows time t4 but is not indicated in any detail in FIG. 2. This is not carried out in the exemplary embodiment according to FIG. 4 either. At time t11, the external temperature increases again and is above the threshold value B2. The setpoint output voltage is, as in FIG. 2, lowered a further three times here on account of the profile of the actuation signal 14. The setpoint output voltage is lowered between times t5 and t6 on account of the increased pressure in the refrigerant between the last and last-but-one lowering operations on account of the profile of the actuation signal 14.

We claim:

1. A method for setting a setpoint output voltage of a generator disposed in a motor vehicle, which comprises the steps of:
lowering the setpoint output voltage of the generator if the setpoint output voltage exceeds a prespecified first threshold value and if an actuation signal for a fan for cooling a motor of the motor vehicle reaches or exceeds a second threshold value.

2. The method according to claim 1, which further comprises:
determining an external temperature; and
lowering the setpoint output voltage only if the external temperature reaches or exceeds a prespecified third threshold value.

3. The method according to claim 1, which further comprises lowering the setpoint output voltage only if, as it rises, the actuation signal for the fan reaches or exceeds the second threshold value.

4. The method according to claim 1, which further comprises lowering the setpoint output voltage for a prespecified first time period.

5. The method according to claim 1, which further comprises:
determining a pressure of a refrigerant for an air-conditioning device of the motor vehicle; and
lowering the setpoint output voltage if the pressure determined reaches or exceeds a prespecified fourth threshold value.

6. The method according to claim 5, which further comprises lowering the setpoint output voltage until the pressure of the refrigerant reaches or falls below a prespecified fifth threshold value.

7. The method according to claim 6, which further comprises setting the fifth threshold value to be lower than the fourth threshold value.

8. The method according to claim 5, which further comprises determining a second time period during which the setpoint output voltage is lowered as a function of the pressure determined.

9. The method according to claim 1, which further comprises adding up times during which the setpoint output voltage of the generator is lowered and a charging period for charging a battery of the motor vehicle is extended as a function of the added times.

10. The method according to claim 1, which further comprises lowering the setpoint output voltage of the generator to the first threshold value.

11. An apparatus for setting a setpoint output voltage of a generator disposed in a motor vehicle, the apparatus comprising:
a control device configured for lowering the setpoint output voltage of the generator if the setpoint output voltage exceeds a prespecified first threshold value and, in addition, if an actuation signal for a fan for cooling a motor of the motor vehicle reaches or exceeds a second threshold value.
